(19) United States
(12) Patent Application Publication
(10) Pub. No.: US 2009/0150228 A1
(43) Pub. Date: Jun. 11, 2009

(54) VOTING PROMOTION ACTIVITY SUPPORT PROGRAM AND VOTING PROMOTION ACTIVITY SUPPORT APPARATUS

(75) Inventors: Koji MARUHASHI, Kawasaki (JP); Hiroshi Yamakawa, Kawasaki (JP); Yoshio Nakao, Kawasaki (JP); Nobuo Watanabe, Kawasaki (JP); Masahiro Asaoka, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/137,885

(22) Filed: Jun. 12, 2008

(30) Foreign Application Priority Data
Jun. 15, 2007 (JP) 2007-159575

(51) Int. Cl. G07C 13/00

(52) U.S. Cl. 705/12

(57) ABSTRACT

An apparatus accepts, from each voter, registration of a free delegation relationship. Then, the apparatus presents voting information such as a vote topic, choices and a voting expiration date to the voter. Next, the apparatus presumes how delegated votes are delegated, during a voting state at a total calculation date, in accordance with the delegation relationships, and estimates a voting result in consideration of delegation of votes. Next, the estimation apparatus sends the estimated voting result to the voters and the administrator for encouraging voter to vote.

### CROSS-REFERENCE TO RELATED APPLICATIONS

This application is based upon and claims the benefit of priority from the prior Japanese Patent Application No. 2007-159575 filed on Jun. 15, 2007, the entire contents of which are incorporated herein by reference.

### BACKGROUND

1. Field

The present invention relates to a computer.

2. Description of the Related Art

As scenes where a decision is made by voters voting for choices, a labor union election, a general meeting of stockholders, an election of board members or a general meeting of a condominium management association or a community association, collection of views about social problems such as environment and city planning, decision of people to be given an award, decision of an off-line meeting in a community, and the like are included. In such decisions, a situation may happen that a decision result on which the general view of all voters is reflected cannot be obtained because only a part of the voters who are strongly interested in voting vote. Therefore, it is common that an administrator in charge of settling a decision encourages voters to vote in order to avoid such a situation.

The activity considered to be the most effective, among such voting promotion activities by an administrator, is that the administrator directly accesses each individual voter to encourage him/her to vote checking his/her situation and circumstances, and requests him/her to cooperate in voting promotion activities for vicinity voters. However, such a method has a problem that the burden on the administrator is too heavy, and it is difficult to encourage a lot of voters to vote within a limited time period before the voting expiration date. Therefore, a method of urging voters to vote by one-way communication means from the administrator to the voters, such as a notice urging voters to vote and a broadcast mail, is often used.

For example, as a technique for supporting such voting promotion activities, Japanese Patent Laid-Open No. 2002-269339 discloses a technique in which a meeting administration/management system performs administration/management of a meetings or the like held by a condominium management association or the like, and supports distribution of information about holding of the meeting, and the like; and the meeting administration/management system also automatically re-notifies holding of the meeting and encourages voting in accordance with whether each member has read the information about the holding of the meeting or the voting state (whether each member has already voted or not).

However, the technique described above has a problem that, since the information sent to voters (members) for promotion of voting is stereotyped information such as information about holding of a meeting (such as a document in which a decision topic and a voting expiration date are shown) and information for urging, it is difficult to expect the effect of promoting voting by voters who are not so interested in voting to be obtained. For example, even in the case of a voter who is not so interested in voting, the possibility that he/she will vote is considered to be strengthened if it is concretely shown to him/her that whether he/she votes or not influences his/her interests. However, such an effect cannot be expected from information such as simple notification of holding a meeting.

Since it is thought to be the most effective from the view point of the promotion effect that an administrator directly encourages individual voters, as described before, a technique for reducing the burden on the administrator is desired. However, such a decision management support technique is not known at present.

### SUMMARY

According to an aspect of an embodiment, a decision result estimation apparatus accepts, from each voter, a free delegation relationship regardless of whether a delegatee voter will vote or not, and stores it in a delegation relationship storage section. Then, the decision result estimation apparatus presents voting information, for example (without limitation) a decision topic, choices or a voting expiration date, or any combinations thereof, to the voter in accordance with an instruction by an administrator and accepts a vote by the voter. Next, the result estimation apparatus presumes how delegated votes are transmitted, in the voting state at a total calculation date, in accordance with the delegation relationships stored in the delegation relationship storage section, and estimates a decision result in consideration of the transmission (delegation) of the delegated votes. Next, the decision result estimation apparatus sends the estimated decision result to the voters and the administrator.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram for illustrating the outline and the characteristics of a voting promotion activity support apparatus according to a first embodiment;

FIG. 2 is a block diagram showing the configuration of a voting promotion activity support apparatus 10 according to the first embodiment;

FIG. 3 is a diagram for illustrating a delegation relationship storage section;

FIG. 4 is a diagram for illustrating a voting state storage section;

FIG. 5 is a diagram for illustrating registration of a free delegation relationship;

FIG. 6 is a diagram for illustrating estimation of the number of votes obtained for each choice;

FIG. 7 is a diagram for illustrating calculation of the total of the estimated number of held votes on the basis of transmission of delegated votes;

FIG. 8 is a diagram for illustrating presentation of influential voters to an administrator;

FIG. 9 is a diagram for illustrating an example of estimation of the number of votes obtained for each choice and calculation of the degree of influence for each voter;

FIG. 10 is a diagram showing an example of a voting promotion comment creation template;

FIG. 11 is a diagram showing an example of a voting promotion comment creation template;

FIG. 12 is a diagram showing an example of a voting promotion comment creation template;

FIG. 13 is a diagram for illustrating notification of voting tendency to a voter;

FIG. 14 is a diagram showing an example of the contents of the voting tendency notification;

FIG. 15 is a diagram showing an example of the contents of the voting tendency notification;

FIG. 16 is a flowchart showing the processing operation by the voting promotion activity support apparatus 10 according to the first embodiment;

FIG. 17 is a flowchart showing the flow of calculation of the estimated number of votes held by each voter;

FIG. 18 is a flowchart showing the flow of creation of a voting promotion message;

FIG. 19 is a flowchart showing the flow of selection of a prevailing choice;

FIG. 20 is a flowchart showing the flow of creation of a voting tendency summary comment;

FIG. 21 is a diagram for illustrating a calculation method using eigenvector centrality; and

FIG. 22 is a diagram showing a computer which executes a voting promotion activity support program.

### DETAILED DESCRIPTION OF THE PREFERRED EMBODIMENTS

The present invention is characterized mainly in that data called a free delegation relationship, which is collected from voters, is utilized to solve the problems described above. The free delegation relationship data is data in which each voter is associated with a different voter to whom the voter delegates use of the vote he/she holds in the case where he/she does not vote himself/herself. In the present invention, this data is basically collected by having each voter register one or more other voters as candidates for a delegatee to whom use of the vote he/she holds is delegated, prior to start of voting. In a conventional decision management system also, it is common that a voter can delegate his/her right to vote to a different voter. However, the ordinary delegation relationship in such a system is a relationship between each voter who does not vote and one voter who votes, and it is assumed that the relationship is used only for one decision (meeting). In comparison with this, the free delegation relationship of the present invention is different in that a voter to be a delegatee is registered irrespective of whether he/she votes or not, and that each voter may register multiple voters as delegatees. Furthermore, it is assumed that the free delegation relationship is repeatedly used for multiple decisions (for example, regular general meetings and the like). In the present invention, the above problems are solved by the configuration described below on the assumption that voting activity promotion information is automatically generated at a predetermined time point after start of voting and before the voting expiration date, on the basis of the free delegation relationship and the state of voting by voters at that time (which choice each of the voters has voted for or whether each of the voters has not voted yet).

A voting promotion activity support apparatus will be described in detail below with reference to accompanying drawings as an embodiment of a voting promotion activity support program and a voting promotion activity support apparatus according to the present invention.

### First Embodiment

In the embodiment below, the outline and the characteristics of a voting promotion activity support apparatus according a first embodiment, and the configuration of and the processing flow by the voting promotion activity support apparatus will be described in that order. Then, at the end, the advantages of the first embodiment will be described.

<Outline and Characteristics of the Voting Promotion Activity Support Apparatus According to the First Embodiment>

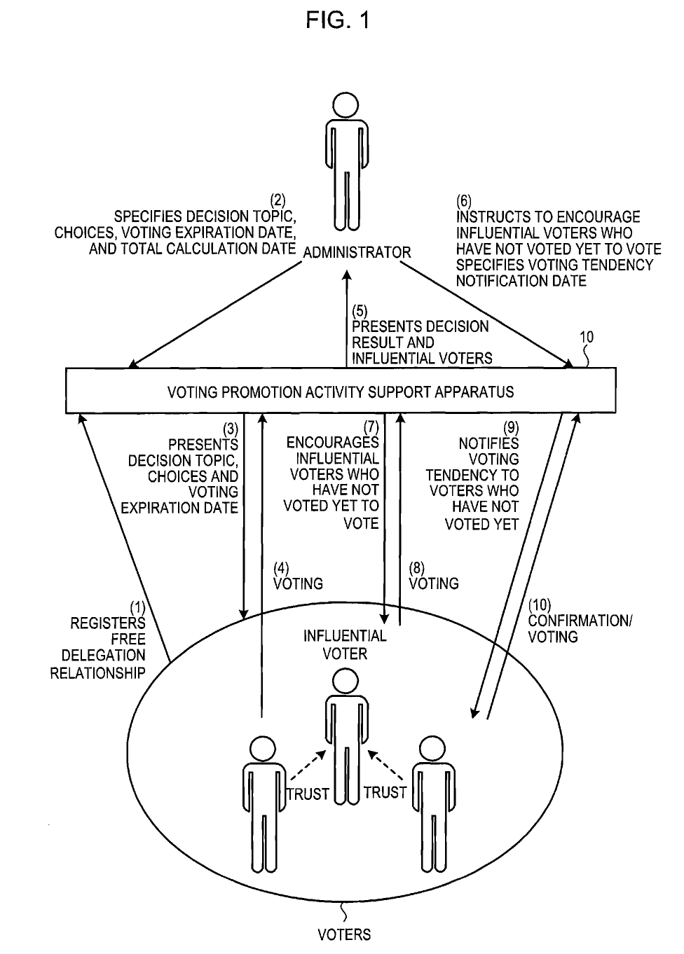

First, the outline and the characteristics of the voting promotion activity support apparatus according to the first embodiment will be described with the use of FIG. 1. FIG. 1 is a diagram for illustrating the outline and the characteristics of the voting promotion activity support apparatus according to the first embodiment.

Briefly, a voting promotion activity support apparatus 10 of the first embodiment generates information for effectively conducting voting promotion activities at the middle stage of a decision (voting) process about a decision to be made by voting by multiple voters on the basis of the voting state at the middle stage. The voting promotion activity support apparatus 10 is characterized mainly in that it becomes possible to effectively encourage a voter having a great influence on a final decision result.

To specifically describe the main characteristic, the voting promotion activity support apparatus 10 is provided with a delegation relationship storage section 13a for storing a delegation relationship by which a delegator, a voter who delegates, and a delegatee, a voter who is delegated by the delegator, are associated with each other.

Under such a configuration, the voting promotion activity support apparatus 10 accepts, from each voter, registration of one or more different voters in advance as candidates for a delegatee to whom use of a part or all of the votes held by the voter is delegated in the case where the voter does not vote, and stores delegation relationship information in which the voter and the delegatee candidates are associated, into the delegation relationship storage section 13a (see (1) in FIG. 1). In the case of a group in which the members (voters) do not change so frequently, such as a union or a residents' association, registration of delegatees may be accepted, for example, when a voter joins the union or the residents' association, and the registered contents may be changed as required. The registration may be performed for each decision (after a decision topic is shown).

Then, the voting promotion activity support apparatus 10 presents a decision topic, choices and a voting expiration date to voters in accordance with an administrator's instruction and accepts votes by the voters (see (2) to (4) in FIG. 1). Here, the administrator's instruction includes basic information of the decision topic, the choices and the voting description as well as a date when calculation of the total of votes in the middle of the voting process is started (a total calculation date).

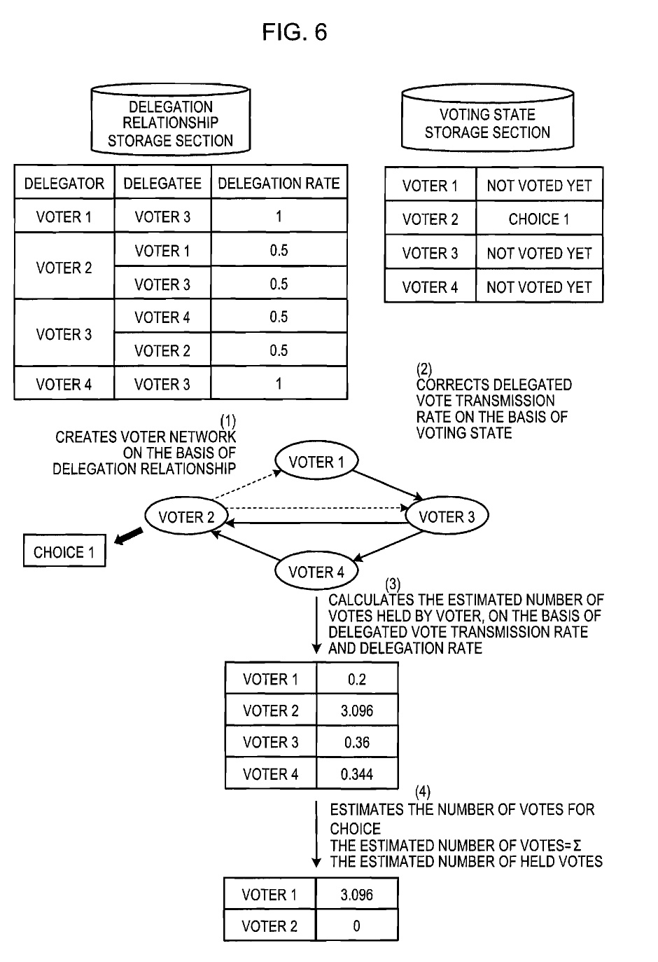

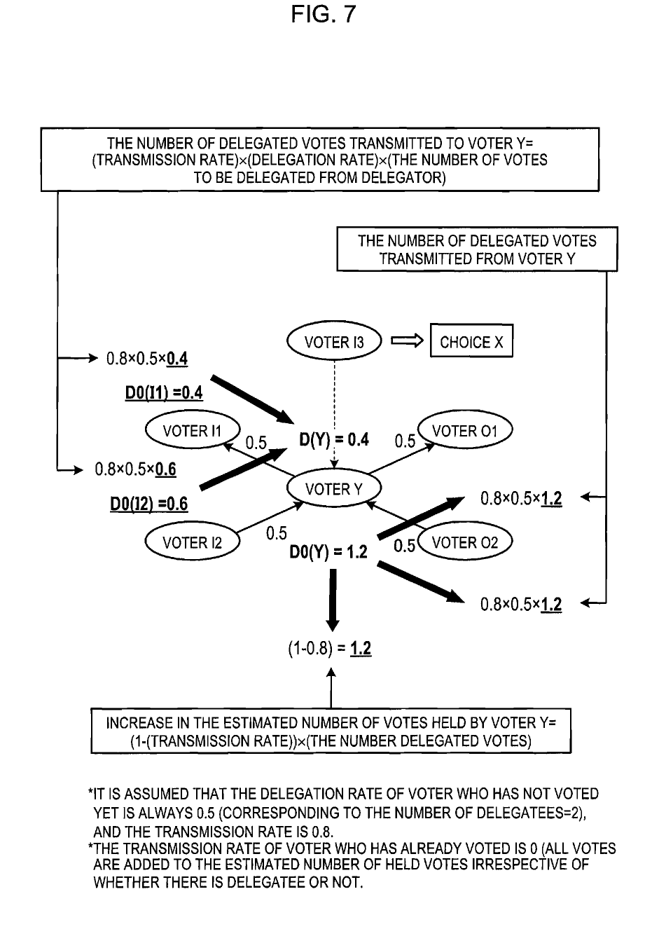

Then, the voting promotion activity support apparatus 10 extracts voters who have not voted yet at a predetermined time point after start of the voting and before the voting expiration date, from a voting state storage section 13a in which voting states are recorded, and it estimates an expected value of the number of votes held by each of the voters, which is the number of votes expected to be finally held by the voter, on the basis of a probability value, which is a value of probability that a voter who has not voted yet does not vote in the end, and the delegation relationship information stored in the delegation relationship storage section 13a, with the use of a calculation model for, in the case where a voter who has not voted yet does not vote in the end, transmitting (delegating) the votes held by the voter to a delegatee as delegated votes and counting the votes as votes held by the transmission destination voter (delegatee voter) (to be described later with the use of FIGS. 6 and 7). Furthermore, by calculating the total of the expected values of the estimated number of held votes for each of the choices for which the voters have voted, the voting promotion activity support apparatus 10 estimates the final number of votes obtained for each choice as a decision result. Then, the voting promotion activity support apparatus 10 identifies such voters that the expected value of the estimated number of held votes is large, as influential voters who should be preferentially encouraged to vote.

Then, the voting promotion activity support apparatus 10 presents the estimated decision result and a list of influential voters and their voting states to the administrator (see (5) in FIG. 1). After that, the voting promotion activity support apparatus 10 creates a voting promotion message and sends it to influential voters who have not voted yet in accordance with an instruction by the administrator (see (6) to (7) in FIG. 1). Here, the voting promotion message is a message created by the administrator for each influential voter, and it may include information helpful for voting, for example, the voting tendency of other voters who have freely delegated the right to the influential voter, an estimated decision result, and the like.

Next, at a voting tendency notification date specified by the administrator, the voting promotion activity support apparatus 10 re-estimates the number of votes obtained for each choice, including the votes which have been cast by the influential voters by that time point, and notifies voting tendency information including the estimation result and a voting promotion message automatically created on the basis of the estimation result to the voters who have not voted yet (see (8) and (9) in FIG. 1).

Here, the voting tendency information notified to each voter includes, in addition to the general voting tendency of all the voters (a voter turnout, and the number of votes/the estimated number of votes for each choice), the voting tendency of other voters (vicinity voters) included in a partial delegation relationship network which includes each notification destination voter. The voting promotion message includes a promotion message automatically selected on the basis of comparison between the voting tendency of the vicinity voters and the general voting tendency of all the voters (for example, “You are recommended to vote yourself because the vicinity voters have conflicting views” or the like).

After that, the voting promotion activity support apparatus 10 accepts votes or confirmation of delegation from voters, including responses from the voters (such as confirmation of voting by influential voters in delegation relationships with the voters, votes for a different choice, and the like) until the voting expiration date (see (10) in FIG. 1).

Thus, the voting promotion activity support apparatus 10 is characterized mainly in that it becomes possible to effectively encourage voters having a great influence on the final decision result as described above.

<Configuration of the Voting Promotion Activity Support Apparatus>

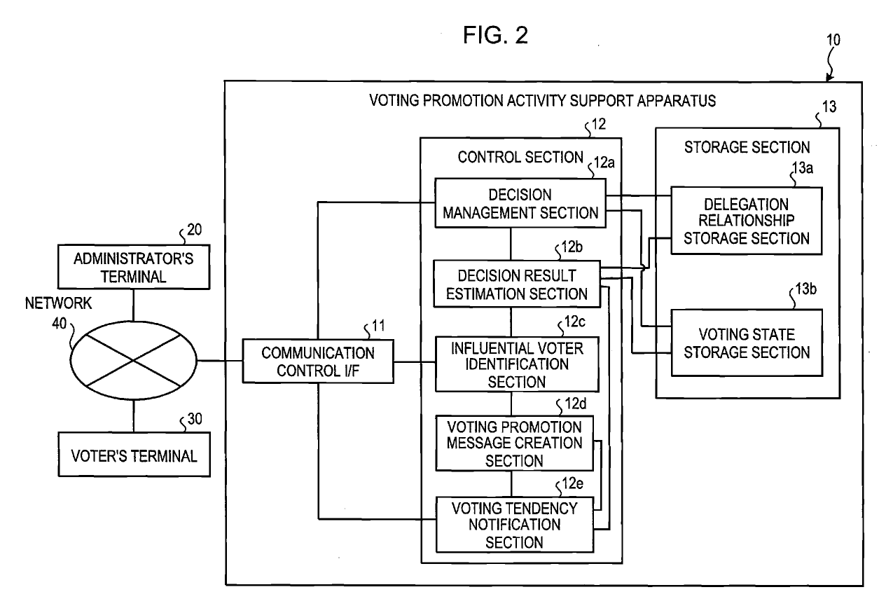

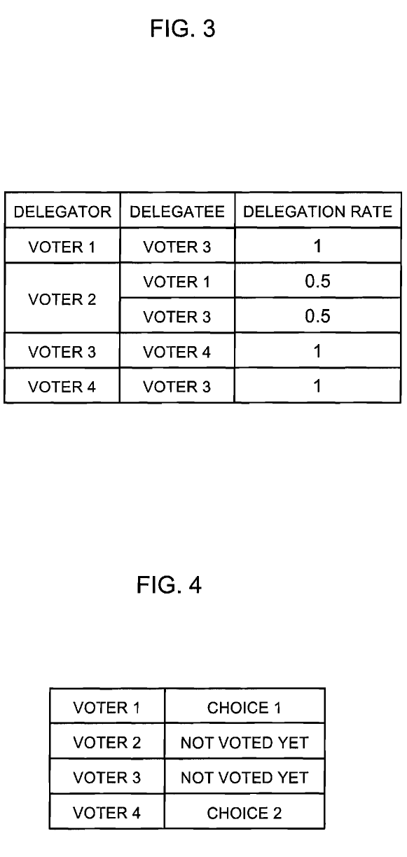

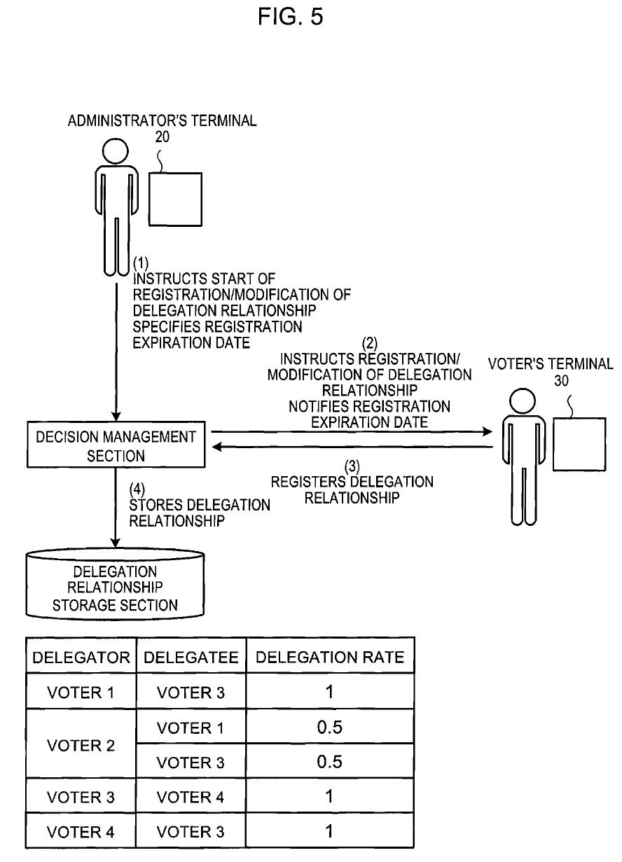

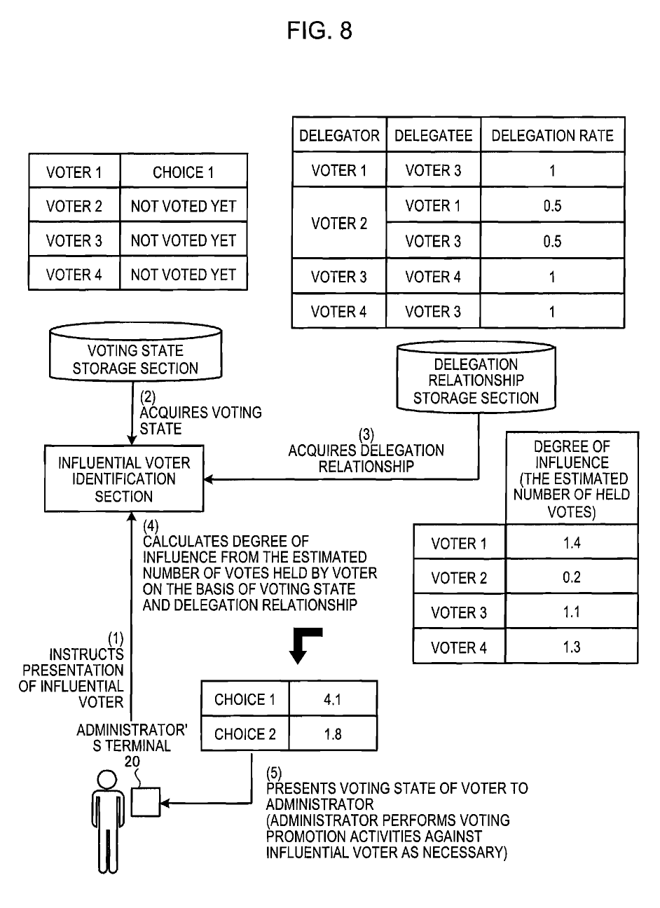

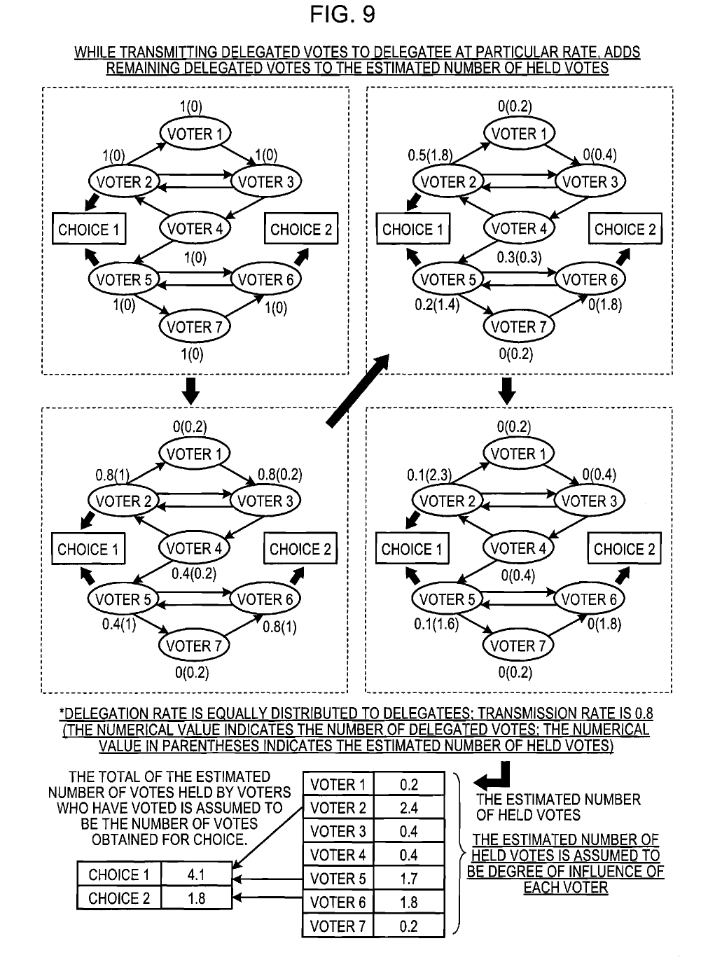

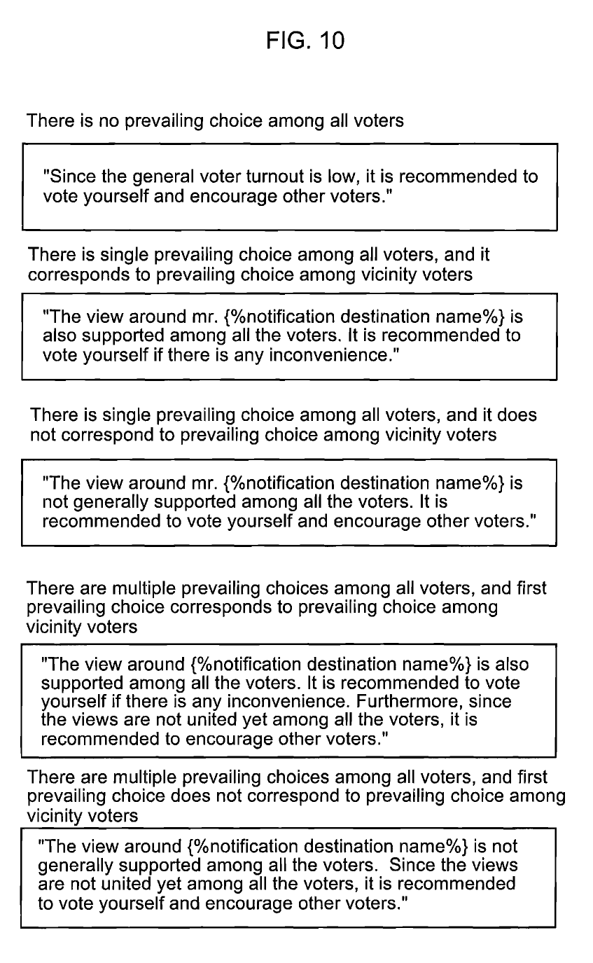

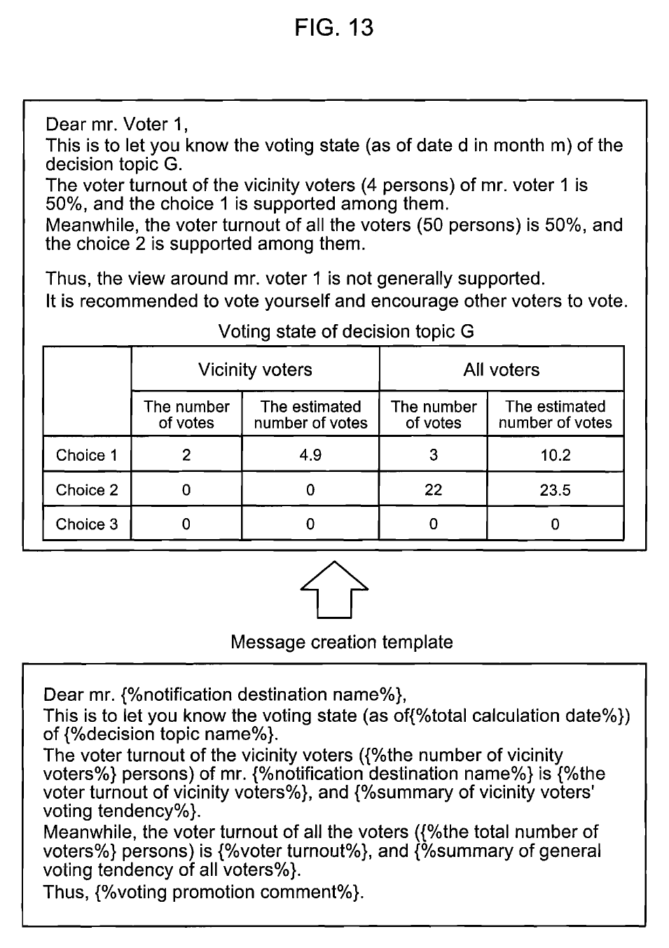

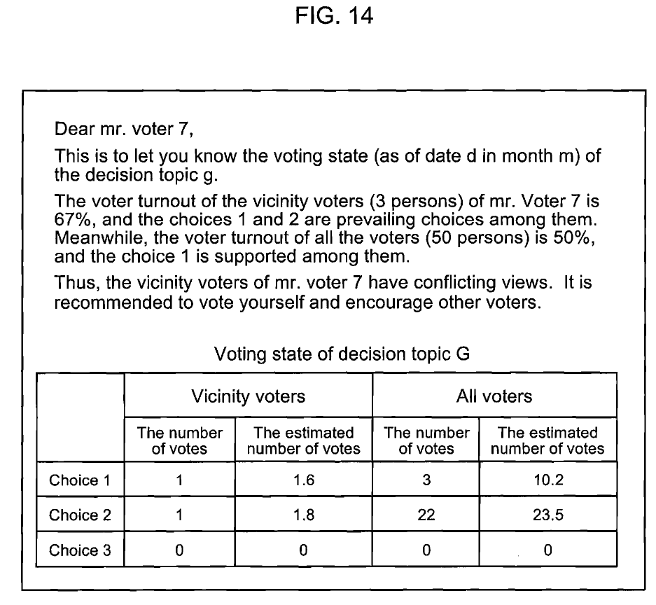

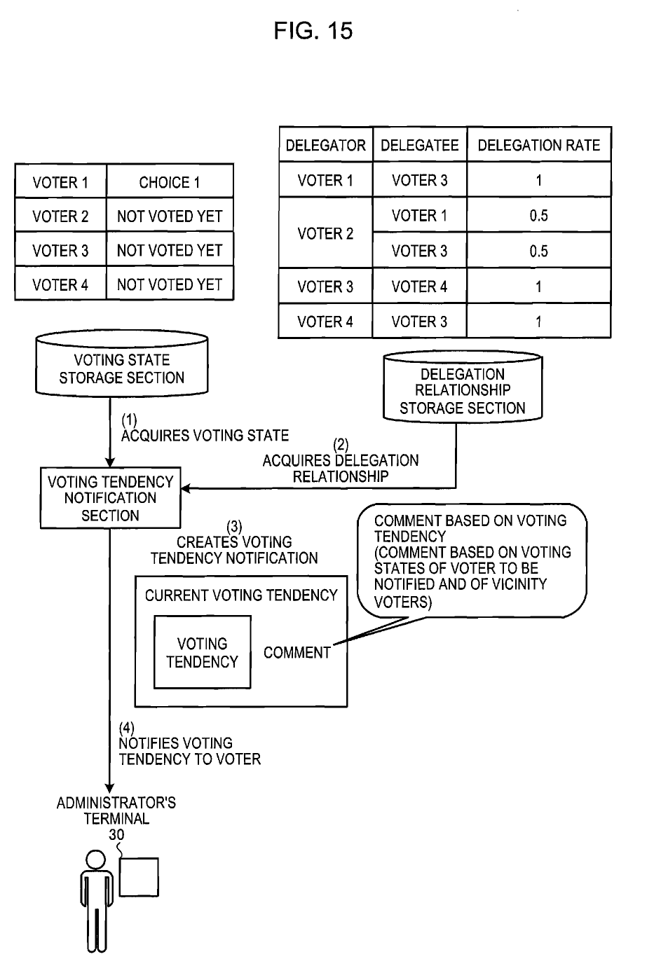

Next, the configuration of the voting promotion activity support apparatus 10 shown in FIG. 1 will be described with FIGS. 2 to 15. FIG. 2 is a block diagram showing the configuration of the voting promotion activity support apparatus 10 according to the first embodiment. FIG. 3 is a diagram for illustrating a delegation relationship storage section. FIG. 4 is a diagram for illustrating a voting state storage section. FIG. 5 is a diagram for illustrating registration of a free delegation relationship. FIG. 6 is a diagram for illustrating estimation of the number of votes obtained for each choice. FIG. 7 is a diagram for illustrating calculation of the total of the estimated number of held votes (the number of votes expected to be held by each voter at the final stage of a decision process (at the time of decision by votes)) on the basis of transmission of delegated votes. FIG. 8 is a diagram for illustrating presentation of influential voters to an administrator. FIG. 9 is a diagram for illustrating an example of estimation of the number of votes obtained for each choice and calculation of the degree of influence for each voter. FIGS. 10 to 12 are diagrams showing an example of a voting promotion comment creation template. FIG. 13 is a diagram for illustrating notification of voting tendency to a voter. FIG. 14 is a diagram showing an example of the contents of the voting tendency notification. FIG. 15 is a diagram showing an example of the contents of the voting tendency notification.

As shown in FIG. 2, this voting promotion activity support apparatus 10 is provided with a communication control I/F 11, a control section 12, a storage section 13, and it is connected to an administrator's terminal 20 and voters' terminals 30 via a network 40. Processing by each of these sections will be described below.

The communication control I/F 11 controls communication of various information exchanged between the administrator's terminal 20 and the voters' terminals 30 connected thereto. Specifically, the communication control I/F 11 presents a decision topic, choices and a voting expiration date from the administrator's terminal 20 to voters, receives votes and the like from the voters, and sends an estimated decision result, influential voters and a list of their voting states to the administrator's terminal 20. Furthermore, the communication control I/F 11 receives delegation-related registration and votes from the voters' terminals 30, and sends a voting promotion message or voting tendency information including the voting promotion message.

The storage section 13 stores data and programs required for various processings performed by the control section 12. Especially as sections closely related to the present invention, the delegation relationship storage section 13a and the voting state storage section 13b are provided. The delegation relationship storage section 13a corresponds to the “delegates storage” described in the claims.

The delegation relationship storage section 13a stores a delegation relationship by which a delegator, a voter who delegates, and a delegatee, a voter who is delegated by the delegator, are associated with each other. Specifically, the delegation relationship storage section 13a stores a delegator, a delegatee and a delegation rate in association with one another as shown in FIG. 3. The delegation rate indicates a rate of delegation to each delegatee in the case where there are multiple delegatees.

The voting state storage section 13b stores the voting state of each voter. Specifically, the voting state storage section 13b stores information about which choice a voter has selected when the voter has voted, and stores information to the effect that a voter has not voted when the voter has not voted yet, in association with a voter identifier which uniquely identifies the voter, as shown in FIG. 4.

The control section 12 has an internal memory for storing programs specifying various processing procedures and the like and necessary data, and it executes various processings based on those. Especially as sections closely related to the present invention, a decision management section 12a, a decision result estimation section 12b, an influential voter identification section 12c, a voting promotion message creation section 12d and a voting tendency notification section 12e are provided. The decision result estimation section 12b corresponds to the “held vote estimator” and the “decision result estimation procedure” described in the claims.

The decision management section 12a accepts, from each voter, registration of one or more different voters as candidates for a delegatee to whom use of a part or all of votes held by the voter is delegated in the case where the voter does not vote, and causes delegation relationship information in which the voter is associated with the delegatee candidates to be stored into the delegation relationship storage section 13a.

Specifically, the decision management section 12a accepts an instruction to start registration/modification of a free delegation relationship together with a registration deadline, from the administrator's terminal 20, as shown in FIG. 5. Then, the decision management section 12a notifies the instruction of registration/modification of a free delegation relationship and the registration date to the voters' terminals 30, and receives registration/modification of delegatees from the voters' terminals 30 by the registration deadline. The decision management section 12a causes the free delegation relationships registered by the voters to be stored into the delegation relationship storage section 13a. When one voter registers multiple delegatees, the decision management section 12a may automatically set a delegation rate (the rate of trust in each delegatee) or the voter himself/herself may specify the delegation rate.

At a predetermined time point after start of voting and before the voting expiration date, the decision result estimation section 12b reads the voting state of each voter at that time point from the voting state storage section 13b in which voting states are recorded, and it estimates an expected value of the number of votes held by the voter, which is the number of votes expected to be finally held by the voter, on the basis of a probability value, which is a value of probability that a voter who has not voted yet at that time point does not vote in the end, and the delegation relationship information stored in the delegation relationship storage section 13a, with the use of a calculation model for, in the case where a voter who has not voted yet at this time point does not vote in the end, transmitting the votes held by the voter to a delegatee as delegated votes and adding the votes as votes held by the transmission destination voter. Furthermore, by calculating the total of the expected values of the estimated number of held votes for each of the choices for which the voters have voted, the decision result estimation section 12b estimates the final number of votes obtained for each choice as the decision result.

Specifically, the decision result estimation section 12b first constitutes a voter network in which voters are assumed to be nodes (four ovals in the center of FIG. 6), and delegation relationships are assumed to be directed edges (thin/dotted arrows in the center of FIG. 6), on the basis of the delegation relationships stored in the delegation relationship storage section 13a, as shown in FIG. 6. Next, the decision result estimation section 12b sets a delegated vote transmission rate for each of the nodes (voters) in consideration of the voting state.

Here, the delegated vote transmission rate is a value corresponding to the probability that the voter delegates his/her vote to a delegatee without voting himself/herself. For a voter who has already voted, 0 (the broken arrow in the center of FIG. 6 indicates that transmission of a delegated vote is not used) is set. For a voter who has not voted yet, a value equal to or less than 1 which is not a negative value (“0.8” in the example in FIG. 6) is set. As the delegated vote transmission rate, a particular value (such as the average rate of direct voting in past decisions) may be uniformly given to all voters. Or, to each individual voter, an appropriate rate (such as the voter's rate of direct voting in the past) may be given. FIG. 6 shows a calculation example in the case where a particular value 0.8 is given to all voters that have not voted yet.

Then, the decision result estimation section 12b calculates an estimated number of held votes for each voter on the basis of the voter network. This calculation processing will be described in detail later with the use of FIGS. 7 and 14. The calculation processing is such that processing for classifying the votes held by each voter into votes to be delegated (the number of held votes×delegated vote transmission rate) and votes to be cast by the voter himself/herself (the number of held votes×(1-delegated vote transmission rate) according to a delegated vote transmission rate, transmitting the former to a delegatee, and adding the latter to the voter's estimated number of held votes is repeated until there is no vote to be transmitted to a delegatee for all voters. After that, for each choice, the decision result estimation section 12b determines the total of estimated number of votes held by the voters who have voted for the choice, and determines the value as the estimated number of votes obtained for the choice.

Here, the method for calculating the estimated number of held votes described above will be described in detail with the use of FIG. 7. FIG. 7 shows the number of votes to be transmitted by one transmission processing for a partial network with a voter Y as the center. Delegated votes corresponding to (transmission rate)×(delegation rate)×(the number of votes to be delegated from delegator) are transmitted from a delegator to delegatees by one transmission processing. However, transmission from a voter who has already voted to a delegatee is not performed (delegation rate=0).

In the example in FIG. 7, the number of votes to be delegated from the voter Y (D0(Y)) at the time of starting the processing (before transmission) is 1.2. Therefore, when assuming that two delegatees, a voter 01 and a voter 02 are delegated with the same weight (delegation rate: 0.5), the number of delegated votes corresponding to 0.8×0.5×1.2=0.48 are transmitted to each of the voters 01 and 02.

To the voter Y, delegated votes are transmitted from two of three voters I1 to I3 who delegate their votes to the voter Y, excluding the voter I3 who has already voted. When the rate of delegation from the voters I1 to I3 to the voter Y is assumed to be 0.5, and the delegation rate of the voters who have not voted (except the voter I3) is assumed to be 0.8, the number of delegated votes corresponding to 0.8×0.5×0.4 from the voter I1 (D0(I1)=0.4) and the number of delegated votes corresponding to 0.8×0.5×0.6 from the voter I2 (D0(I1)=0.6) are transmitted to the voter Y, and therefore, the number of votes delegated to the voter Y (D(Y)) becomes 0.4 after the processing ends.

Furthermore, the number of votes corresponding to (1-(delegation rate)×(the number delegated votes) is added to the estimated number of votes held by each voter, from the number of votes to be delegated from the voter, by one transmission. However, as for a voter who has already voted, the number of all the delegated votes is added to the estimated number of held votes (1-(transmission rate)=1). In the example in FIG. 7, since the number of votes to be delegated from the voter Y (D0(Y)) before transmission is 1.2, the estimated number of votes held by the voter Y is increased by (1-0.8)×1.2 after transmission. As described above, FIG. 7 shows the number of votes transmitted by one transmission processing. By repeating the above processing subsequently, the value of the estimated number of held votes totaled is calculated for each voter.

The influential voter identification section 12c identifies such a voter that the expected value of the estimated number of held votes is large as an influential voter who should be preferentially encouraged to vote. Specifically, as shown in FIG. 8, when receiving an instruction to present influential voters from the administrator during a voting period, the influential voter identification section 12c calculates the estimated number of votes held by each voter on the basis of the delegation relationships stored in the delegation relationship storage section 13a and the voting states recorded in the voting state storage section 13b, regards the value as the degree of influence of the voter, and identifies voters having a high degree of influence as influential voters. Then, the influential voter identification section 12c notifies the influential voters and their voting states to the administrator's terminal 20.

Here, the calculation of the degree of influence of a voter and the estimation of the number of votes obtained for each choice which have been described above will be described in detail using an example, with the use of FIG. 9. As described before, the decision result estimation section 12b transmits a particular rate (transmission rate) of delegated votes among delegated votes held by each voter to a delegatee on the basis of the free delegation relationship, and adds the remaining delegated votes to the estimated number of votes held by the voter to calculate.

Here, the number of votes obtained for each choice refers to the total of the estimated number of votes held by voters who have voted for the choice, and the degree of influence of each voter refers to the value of the estimated number of votes held by each voter. This will be described below using the example in FIG. 9. In this figure, voters are indicated by oval nodes; choices are indicated by rectangular nodes; free delegation relationships are indicated by thin directed edges; and the voting states are indicated by thick edges. In this example, the delegation rate is equally distributed to delegatees. That is, in the case where one delegatee is delegated, the delegation rate is set to 1; in the case where two delegatees are delegated, the delegation rate for each delegatee is uniformly set to 0.5. The transmission rate of a voter who has not voted is set to 0.8. The number of delegated votes is shown beside the voter, and the estimated number of held votes is shown in parentheses.

FIG. 9 shows the transition of the number of delegated votes and the estimated number of held votes for each voter when the transmission processing is repeated three times. In this example, the number of votes to be delegated from each voter becomes 0 by performing transmission four times. The number of votes obtained for a choice 1 is the sum of the estimated number of votes held by voters 2 and 5 who have voted for the choice 1, and the number of votes obtained for a choice 2 is the value of the estimated number of votes held by a voter 6 who is the only voter who has voted for the choice 2. The value of the estimated number of votes held by each voter is regarded as the degree of influence. In this case, the most influential voters who have not voted yet are voters 3 and 4.

At a voting tendency notification date specified by the administrator, the voting promotion message creation section 12d re-estimates the number of votes obtained for each choice, including the votes which have been cast by influential voters by that time point, and creates an estimation result and a voting promotion message based on the estimation result. Specifically, the voting promotion message creation section 12d selects prevailing choices among vicinity voters. Here, the prevailing choices refers to a choice having the largest estimated number of obtained votes (the first prevailing choice) and other choices having the estimated number of votes equal to or larger than 1/R (R is a preset threshold; natural number) of the estimated number of obtained votes. However, in the case where the rate of direct voting of a targeted set of voters is below a particular percentage (P %) set in advance, there is no prevailing choice (judgment impossible). Then, the voting promotion message creation section 12d selects prevailing choices among all the voters in a similar procedure.

Then, the voting promotion message creation section 12d creates a voting tendency summary comment for each of the set of vicinity voters and the set of all the voters on the basis of the prevailing choices. After that, the voting promotion message creation section 12d selects a voting promotion comment creation template from a template storage section not shown on the basis of the prevailing choices in the set of vicinity voters and the prevailing choices in the set of all the voters, and creates a voting promotion comment by inserting an appropriate value (in the example, a notification destination name) into a variable part (by inserting an appropriate value into a part surrounded by {%%}) in the template). That is, the voting promotion message creation section 12d judges whether there is no, a single, or multiple prevailing choices among the vicinity voters.

As a result, if judging that there is a single prevailing choice (L1 type), the voting promotion message creation section 12d selects a voting promotion comment creation template in accordance with the general prevailing choice among all the voters as illustrated in FIG. 10. For example, in the case of judging that there is no general prevailing choice among all the voters, the voting promotion message creation section 12d creates a voting promotion comment with the use of a template saying, “Since the general voter turnout is low, it is recommended to vote yourself and encourage other voters.”

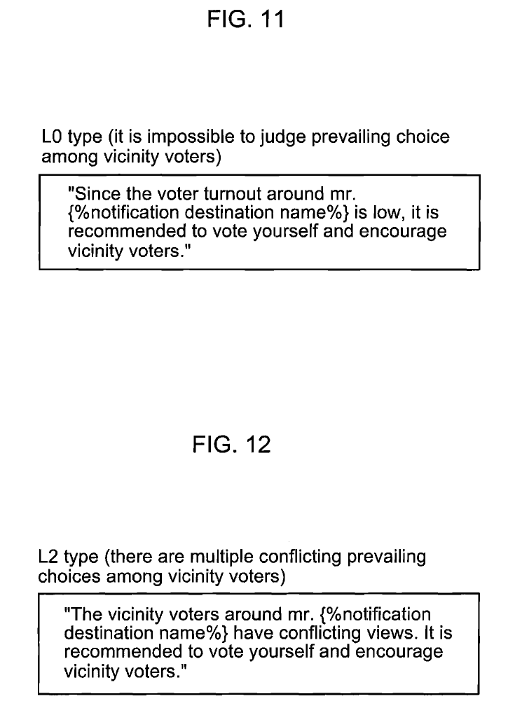

In the case of judging that there is no prevailing choice among the vicinity voters (L0 type), the voting promotion message creation section 12d creates a voting promotion comment with the use of a template saying, “Since the voter turnout around Mr. {% notification destination name %} is low, it is recommended to vote yourself and encourage vicinity voters” as illustrated in FIG. 11.

In the case of judging that there are multiple prevailing choices among the vicinity voters (L2 type), the voting promotion message creation section 12d creates a voting promotion comment with the use of a template saying, “As shown, vicinity voters around Mr. {% notification destination name %} have conflicting views. It is recommended to vote yourself and encourage the vicinity voters” as illustrated in FIG. 12.

Next, an example of the contents of the voting tendency notification will be described with the use of FIGS. 13 and 14. As shown in FIG. 13, the voting tendency information includes the voting tendency of vicinity voters and the general voting tendency of all voters, and a message automatically created in accordance with the voting tendencies to encourage a voter to act (a voting promotion message). The vicinity voters' voting tendency and the general voting tendency are information configured by the voter turnout, calculation of the total of direct votes for each choice (the number of direct votes obtained), and estimation based on the estimated number of held votes (the estimated number of obtained votes). The voting promotion message includes a comment showing the summary of the voting tendency (a voting tendency summary comment) and an example of a recommended voting action (a voting promotion comment). The voting promotion message is created by inserting an appropriate value into a part surrounded by {%%} in a template on the basis of the templates illustrated in FIGS. 10 to 12.

In the example in FIG. 13, a voting promotion comment is created which says, “The view around Mr. Voter 1 is not generally supported. It is recommended not only to vote yourself but encourage other voters” (using the L1 type template in FIG. 10 which is intended to be used for the case where a single and general prevailing choice do not correspond to the prevailing choice among vicinity voters). In the example in FIG. 14, a voting promotion comment is created which says, “As shown, the vicinity voters around Mr. Voter 7 have conflicting views. It is recommended to vote yourself and encourage the vicinity voters” (using the L12 type template in FIG. 12).

The voting tendency notification section 12e sends an estimated decision result to the voters' terminals 30 and the administrator's terminal 20. Specifically, the voting tendency notification section 12e sends influential voters identified by the influential voter identification section 12c and an estimated decision result to the administrator. Furthermore, the voting tendency notification section 12e notifies voting tendency information which includes a voting promotion message created by the voting promotion message creation section 12d, to voters who have not voted yet.

Here, the notification of voting tendency to voters will be described with the use of FIG. 15. The voting tendency notification section 12e notifies voting tendency estimated by the decision result estimation section 12b to the voters' terminals 30. To this voting tendency, the voting states of a notification destination voter and his/her direct delegated/delegating voters (vicinity voters) and a comment based on the voting states are attached. Though the notification of the voting tendency is assumed to be performed on the voting tendency notification date specified by the administrator, it is also conceivable to perform the notification, for example, at a timing when an influential voter votes.

<Processing by the Voting Promotion Activity Support Apparatus>

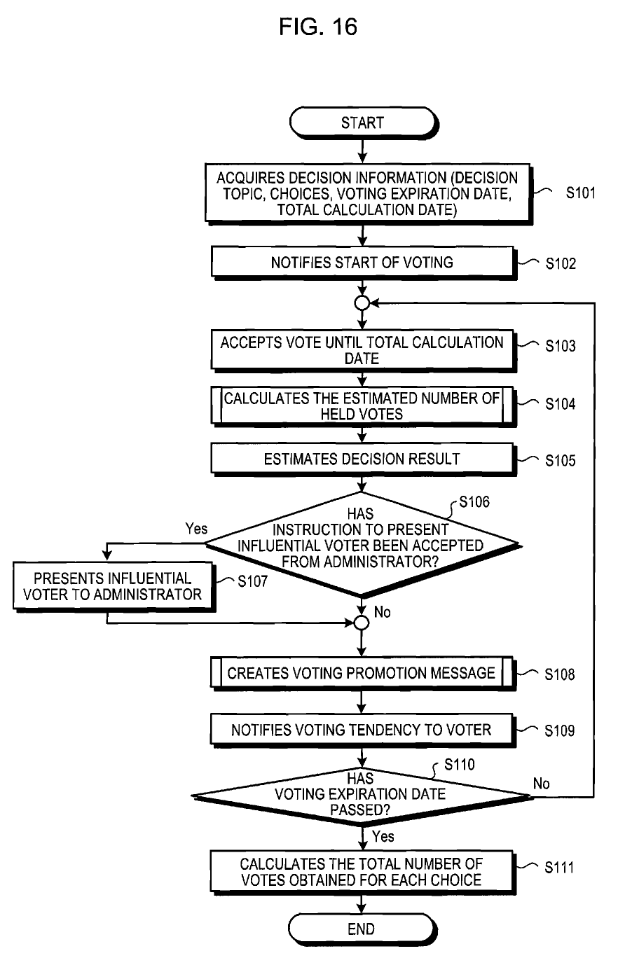

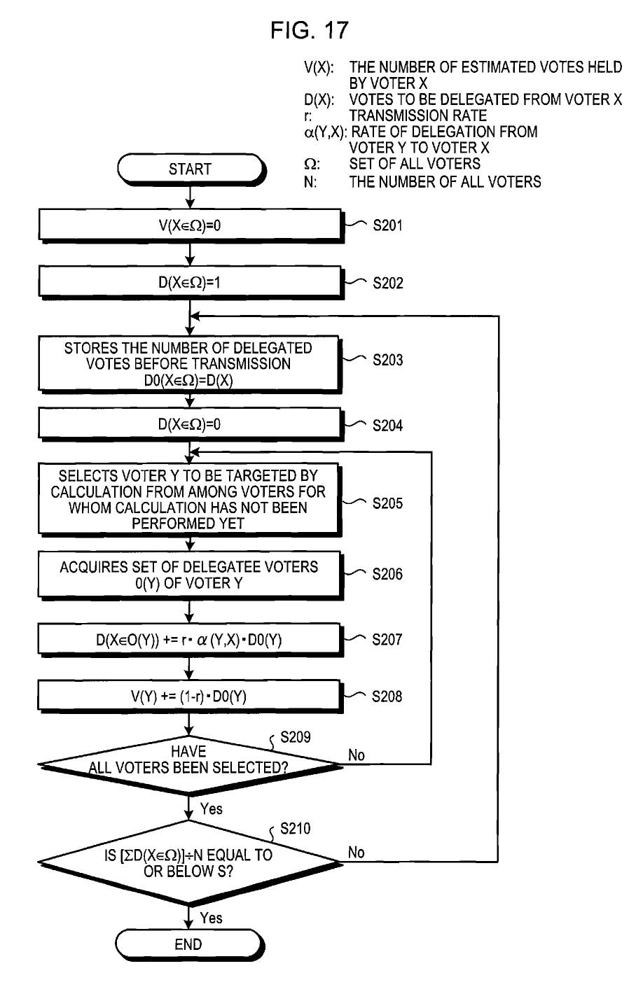

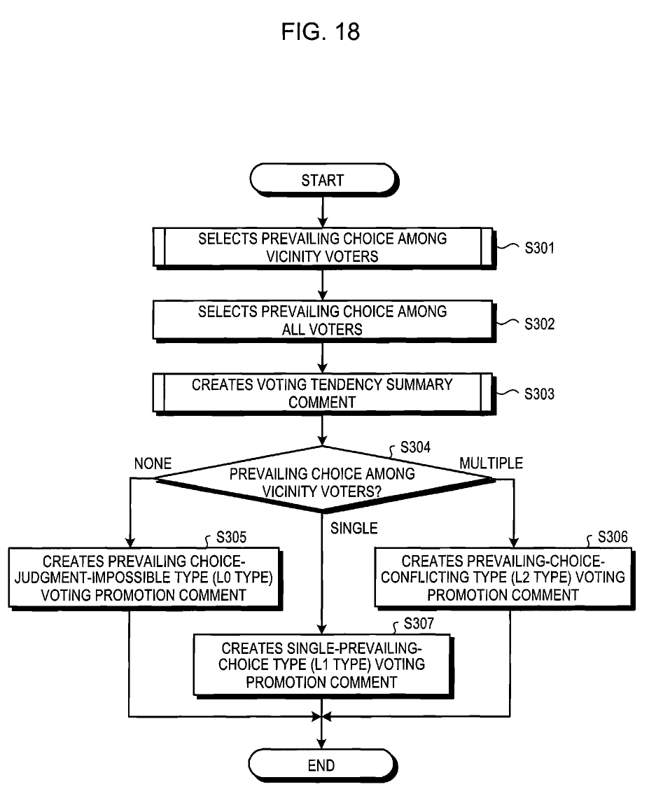

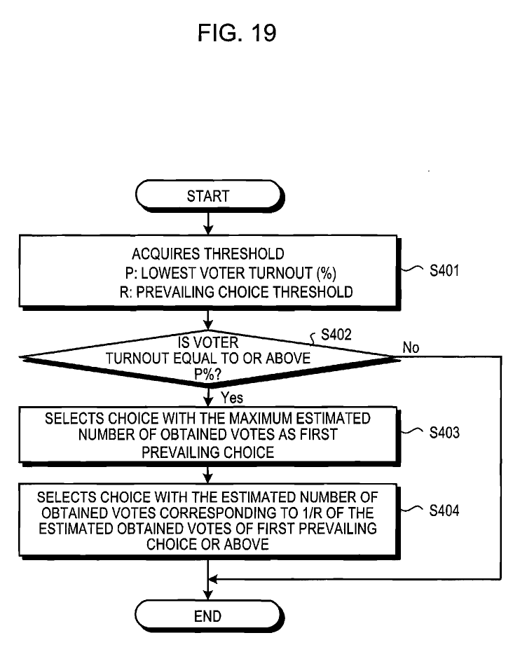

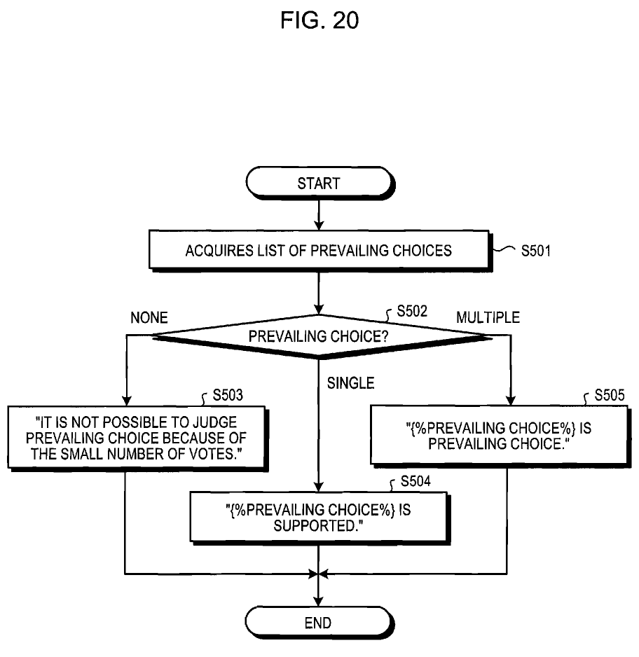

Next, the processing by the voting promotion activity support apparatus 10 according to the first embodiment will be described with the use of FIGS. 16 to 20. FIG. 16 is a flowchart showing the processing operation by the voting promotion activity support apparatus 10 according to the first embodiment. FIG. 17 is a flowchart showing the flow of calculation of the estimated number of votes held by each voter. FIG. 18 is a flowchart showing the flow of creation of a voting promotion message. FIG. 19 is a flowchart showing the flow of selection of a prevailing choice. FIG. 20 is a flowchart showing the flow of creation of a voting tendency summary comment.

As shown in FIG. 16, the voting promotion activity support apparatus 10 receives decision or voting information (e.g., a decision topic, choices, a voting expiration date and a total calculation date) from the administrator's terminal 20 (S101) and notifies start of voting to each of the voters' terminals 30 (S102). In this case, the voting promotion activity support apparatus 10 notifies the decision topic, the choices and the voting expiration date to the voters' terminals 30, and accepts registration and modification of delegatees from each of the voters' terminals 30 as necessary.

Then, the voting promotion activity support apparatus 10 accepts votes by voters for a predetermined period (until a total calculation date specified by the administrator), and records the votes by the voters in a voting state table (S103). After the predetermined period, the voting promotion activity support apparatus 10 performs processing for calculating the estimated number of held votes (to be described in detail later with the use of FIG. 17) on the basis of the voting state at that time point (S104) to estimate a decision result (S105).

Next, after estimation of the decision result, the voting promotion activity support apparatus 10 accepts an instruction to present influential voters, from the administrator's terminal 20 (S106). If there is an instruction to present influential voters, from the administrator (S106: YES), the voting promotion activity support apparatus 10 identifies influential voters by regarding the estimated number of votes held by the voters calculated on the basis of delegation relationships and the voting states of the voters as the degree of influence of the voters, and notifies the influential voters to the administrator's terminal 20 (S107).

In this case, the voting promotion activity support apparatus 10 receives a date when the voting promotion activities against influential voters end (or a date when notification of voting tendency starts) from the administrator's terminal 20, and performs re-estimation of a decision result on the day. The administrator performs voting promotion activities against the presented influential voters as necessary until the date when the voting promotion activities end.

Then, the voting promotion activity support apparatus 10 creates a voting promotion message as necessary after the date when the promotion activities end (S108), and notifies voting tendency to each voter (S109). Furthermore, the voting promotion activity support apparatus 10 checks whether the voting expiration date specified by the administrator has passed at this time point (S110). If the voting expiration date has not passed yet (S110: NO), the processing beginning with acceptance of votes for the predetermined period (S103) is repeated. On the other hand, if the voting expiration date has already passed, the voting promotion activity support apparatus 10 calculates the decision result and notifies it to the administrator and the voters (S111). In the case where the administrator selects an administration policy that the estimated value of a decision result based on free delegation relationships should be regarded as a final decision result, the voting promotion activity support apparatus 10 performs the estimation of a decision result at S105 instead of performing simple calculation of the total number of votes, and notifies the estimation result to the administrator's terminal 20.

Next, the flow of calculation of the estimated number of votes held by each voter will be described with the use of FIG. 17. As shown in the figure, the voting promotion activity support apparatus 10 sets, for all the voters, an initial value 0 as the estimated number of held votes (S201) and sets, for all the voters, an initial value 1 as the number of delegated votes (S202). Next, the voting promotion activity support apparatus 10 stores, for all the voters, the number of delegated votes as the number of delegated votes before transmission (S203). Then, the voting promotion activity support apparatus 10 sets, for all the voters, 0 as the number of delegated votes (S204), and selects one voter to be targeted by calculation from among the voters for whom calculation has not been performed yet (S205).

Next, the voting promotion activity support apparatus 10 acquires a set of delegatee voters of the selected voter Y 0(Y) (S206). Then, the voting promotion activity support apparatus 10 adds (transmission rate)×(rate of delegation from voter Y to voter X)×(the number of votes to be delegated from voter Y before transmission) to the number of votes to be delegated from a voter X belonging to 0(Y) (S207). After that, the voting promotion activity support apparatus 10 adds (1−(transmission rate))×(the number of votes to be delegated from voter Y before transmission) to the estimated number of votes held by the voter Y (S208). Then, the voting promotion activity support apparatus 10 judges whether all the voters have been selected (S209). If all the voters have not been selected yet (S209: NO), the processings from S205 to S209 are repeated.

After that, the voting promotion activity support apparatus 10 judges whether the rate of the total number of votes to be delegated from all the voters to the number of all the voters is equal to or below a predetermined rate S or not (S210). As a result, if the rate of the total number of votes to be delegated from all the voters to the number of all the voters is not equal to or below the predetermined rate S (S210: NO), the voting promotion activity support apparatus 10 repeats the processings from S203 to S210 until the rate of the total number of votes to be delegated from all the voters to the number of all the voters becomes equal to or below the predetermined rate S. If the rate of the total number of votes to be delegated from all the voters to the number of all the voters is equal to or below the predetermined rate S (S210: YES), the voting promotion activity support apparatus 10 ends the processing.

In this procedure, processing for performing divided transmission by stages while gradually decreasing the initial value (one vote) of each node (voter) at a constant rate (S203 to S209) is repeated until the convergence condition at S210 is satisfied. Mathematically, this procedure is equivalent to the procedure for determining the first eigenvector by eigenvalue decomposition. The calculation result asymptotically corresponds to a value called “network centrality (eigenvector centrality)” which is utilized in analysis of a social network and the like.

Next, the flow of calculation of the estimated number of votes held by each voter will be described with the use of FIG. 18. As shown in the figure, the voting promotion message creation section 12d of the voting promotion activity support apparatus 10 selects a prevailing choice among vicinity voters (S301), and selects a prevailing choice among all voters (S302).

Then, the voting promotion activity support apparatus 10 creates a voting tendency summary comment for each of the set of vicinity voters and the set of all the voters on the basis of the prevailing choices (S303). After that, the voting promotion activity support apparatus 10 judges whether there is no, a single, or multiple prevailing choices among the vicinity voters (S304).

As a result, if judging that there is a single prevailing choice among the vicinity voters (L1 type) (S304: SINGLE), the voting promotion activity support apparatus 10 selects a voting promotion comment creation template in accordance with the prevailing choice among all the voters and creates a voting promotion comment using the template, as illustrated in FIG. 10 described above (S307).

If judging that there is no prevailing choice among the vicinity voters (L0 type) (S304: NONE), the voting promotion activity support apparatus 10 creates a voting promotion comment with the use of the template saying, “Since the voter turnout around Mr. {% notification destination name %} is low, it is recommended to vote yourself and encourage vicinity voters” as illustrated in FIG. 11 (S305). If judging that there are multiple prevailing choices among the vicinity voters (L2 type) (S304: MULTIPLE), the voting promotion activity support apparatus 10 creates a voting promotion comment with the use of the template saying, “As shown, the vicinity voters around Mr. {% notification destination name %} have conflicting views. It is recommended to vote yourself and encourage the vicinity voters” as illustrated in FIG. 12 (S306).

Next, the flow of selection of a prevailing choice will be described with the use of FIG. 19. As shown in the figure, the voting promotion activity support apparatus 10 acquires the lowest voter turnout (P %) and a prevailing choice threshold (R) (S401), and judges whether the voter turnout is equal to or above the lowest voter turnout (S402). As a result, if the voter turnout is equal to or above the lowest voter turnout (S402: YES), the voting promotion activity support apparatus 10 selects such a choice that the estimated number of obtained votes is the largest as the first prevailing choice (S403), and adds such choices that the estimated number of obtained votes is equal to or above 1/R of the estimated number of votes obtained for the first prevailing choice to a list of prevailing choices (S404). If the voter turnout is not equal to or above the lowest voter turnout (S402: NO), the voting promotion activity support apparatus 10 ends the processing.

Next, the flow of creation of the voting tendency summary comment will be described with the use of FIG. 20. As shown in the figure, the voting promotion activity support apparatus 10 acquires a list of prevailing choices (S501), and judges whether no, a single, or multiple prevailing choices have been acquired (S502). As a result, if no prevailing choice has been acquired (S502: NONE), the voting promotion activity support apparatus 10 creates a comment saying, “It is not possible to judge a prevailing choice because of the small number of votes” as the voting tendency summary comment (S503).

If a single prevailing choice has been acquired (S502: SINGLE), the voting promotion activity support apparatus 10 creates a comment saying, “{% prevailing option %} is supported” as the voting tendency summary comment (S504). If multiple prevailing choices have been acquired (S502: MULTIPLE), the voting promotion activity support apparatus 10 creates a comment saying, “{% prevailing option %} is prevailing option” as the voting tendency summary comment (S505).

<Advantages of the First Embodiment>

As described above, the voting promotion activity support apparatus 10 calculates the estimated number of held votes (an expected value of the final number of held votes) for each voter in consideration of the probability that, if the voter has not voted yet at a predetermined time point, does not vote in the end and transmission of delegated votes in accordance with free delegation relationships, identifies voters having a large estimated number of held votes as influential voters who should be preferentially encouraged to vote and notifies the influential voters to an administrator. As a result, it is possible for the administrator to effectively encourage voters having a great influence on the final decision result (voters having a large number of held votes including delegated votes) by performing voting promotion activities limiting the target to the notified influential voters.

Furthermore, according to the first embodiment, by calculating the total of the expected values of votes held by voters who have voted for each choice, the final number of votes obtained for each choice is estimated, a list of estimated values of the number of votes for the choices (general voting tendency of all the voters) is created, and it is notified to the administrator and the voters. The number of obtained votes estimated by this procedure not only reflects the intention of voters who have already voted at that time point but also indirectly reflects the intention of voters who have not voted yet on the basis of free delegation relationships, due to the nature of the expected value of the number of held votes described above. Therefore, it can be expected that the value is a predictive value of a final decision result with a higher accuracy than that of a simple number of votes obtained for each choice. As a result, for example, even when the number of voters who directly vote for choices is small, it is expected that a predictive value of a final decision result with high reliability can be obtained if many of the influential voters have already voted. Thus, an advantage is obtained that the voters and the administrator can quickly recognize a prevailing choice and the like to be considered by referring to the list information about the estimated values of the number of obtained votes which has been created by this procedure. Furthermore, an advantage of encouraging voting or voluntary voting promotion activities by voters to whom a decision result has a great influence on their interests can be expected. For example, in the case where there are such multiple choices that the difference in the number of votes finally obtained will probably be slight, it is expected that a voter whose interests will be significantly changed by which choice is adopted in the end voluntarily starts voting promotion activities.

Furthermore, according to the first embodiment, a list (vicinity voters' voting tendency) is created for each voter in which, for each option, the total of the expected values of the number of votes held by his/her vicinity voters (different voters associated with the voter by direct delegation relationships) extracted by a vicinity voter extraction procedure are calculated, and it is notified to the voter together with a list in which the general voting tendency of all the voters is described. Since it can be expected that voters directly associated with each other by a delegation relationship resemble with each other in the sense of values and interests, it is expected that the list showing the vicinity voters' voting tendency suggests the voting tendency of voters who resemble the voter in the sense of values and interests. Therefore, each voter can easily grasp the situation in which he/she is placed by comparing the list about the voting tendency of his/her vicinity voters and the list information about the general tendency of all the voters. For example, in the case where a prevailing choice (a choice with a large expected value of the number of obtained votes) in the list about the vicinity voters is not generally supported (the expected value of the number of obtained votes is relatively small) in the list about all the voters, the voter can easily recognize that the view of the voters who resemble himself/herself in the sense of values and interests is not generally supported among all the voters.

Furthermore, according to the first embodiment, for each voter, a prevailing choice among his/her vicinity voters and a prevailing choice among all the voters are automatically selected, and a voting promotion message (voting promotion information) is created on the basis of a template selected in accordance with whether the prevailing choices correspond to each other or not. Thereby, the administrator can automatically create a voting promotion message thought to be effective in the situation of each individual voter's situation and send it to each voter only by preparing a relatively small number of templates corresponding to differences between a prevailing choice among vicinity voters and a prevailing choice among all voters. For example, by preparing two kinds of templates, it becomes possible to realize that, to a voter who has not voted yet though the prevailing choice among his/her vicinity voters and the prevailing choice among all voters correspond to each other, a message is automatically sent which confirms whether the voter agrees with the prevailing choice among the vicinity voters, and to such a voter that the prevailing choice among his/her vicinity voters and the prevailing choice among all voters do not correspond to each other, a message is automatically sent which notifies that it is necessary to encourage other voters in order that a decision on which his/her own view is reflected is made. Furthermore, by preparing the templates as shown in FIGS. 10 to 12, it is possible to send a voting promotion message customized in detailed consideration of the situation of a message notification destination voter as in the examples in FIGS. 13 and 14.

### Second Embodiment

An embodiment of the present invention has been described. However, the present invention may be practiced in various different embodiments other than the embodiment described above. Therefore, another embodiment included in the present invention will be described below as a second embodiment.

(1) Calculation of the Estimated Number of Held Votes

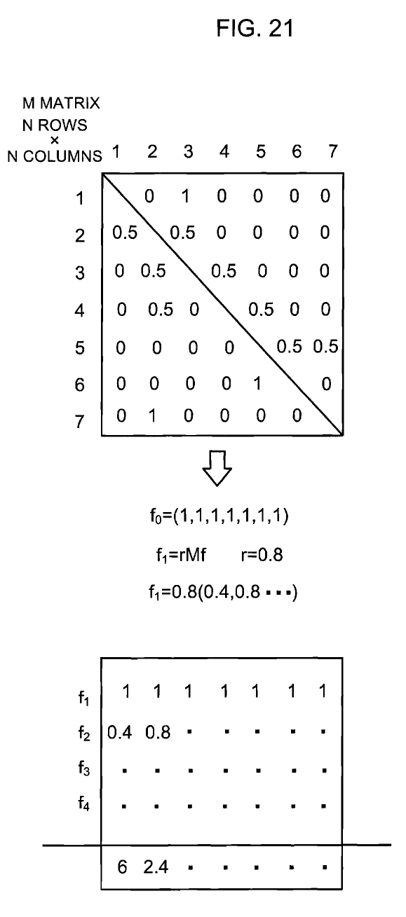

As another embodiment of the method for calculating the estimated number of held votes in the present invention, the method shown in FIG. 21 and described below is also conceivable. It is assumed that a matrix with a size of N′N which includes delegation relationships among K voters stored in the delegation relationship storage section and voting relationships between the K voters and L choices stored in the voting state storage section is called a voting matrix M (N=K+L).

When a voter i delegates a vote to a voter j or when the voter i votes for a choice j, the rate of the delegation or the voting is set for an element Mij. Otherwise, 0 is set. Next, as the initial value of a vote flow vector f(t), an L-line column vector f(0)=(1, . . . , 1)T is set in which one vote is set for a voter and for a choice. Then, calculation of multiplying the vote flow vector f(t) by a transmission rate r (0≦r≦1) and a vote matrix W is repeated until an appropriate convergence condition is satisfied.

f(t+1)=rMf(t) (1)

The convergence condition can be, for example, that the maximum value of f(t), which is an element of the vote flow vector f(t), becomes equal to or below a particular value (see Equation (2)). Lastly, the sum total of the vote flow vector is set as an estimated number of held votes F.

$$\begin{matrix}max ( {f}_{i} ) < 0.0001 & ( 2 ) \\ F = {\sum }_{t = 0}^{T} f ( t ) & ( 3 )\end{matrix}$$

One vote is set for a choice as an initial value. However, since it is natural that the number of votes for a choice for which no vote has been cast is 0, a value obtained by subtracting 1 from F is set as the final estimated number of held votes for a choice.

(2) Identification of Influential Voters

In the first embodiment described above, a case where a voter with a large number of the estimated number of held votes is regarded as an influential voter is explained to describe a method for identifying an influential voter. However, the present invention is not limited to thereto, and it is also possible to regard a voter with a large number of votes as an influential voter. Further, according to an aspect of the embodiment, the voting promotion activity can be performed as a voting simulation, before, during, and/or after (not subject to/without a voting expiration date) actual voting takes place. Further, any of the described calendar/time dates can be manually, dynamically and/or automatically settable.

According to an aspect of an embodiment, an apparatus accepts, from each voter, registration of a vote delegation relationship. Then, the apparatus presents voting information such as a vote topic, choices and a voting expiration date to the voter. Next, the apparatus presumes or estimates how delegated votes are delegated, during a voting state at a total calculation date, in accordance with the delegation relationships, and estimates a voting result in consideration of delegation of votes. Next, the estimation apparatus sends the estimated voting result to the voters and the administrator for encouraging voter to vote.

(3) System Configuration and the Like

The components of each apparatus shown in the figures are functionally conceptually shown, and they are not necessarily required to be physically configured as shown in the figures. That is, the specific form of distribution/integration for each apparatus is not limited to that shown in the figures, and it is possible to functionally or physically distribute/integrate all or a part thereof in arbitrary units in accordance with various loads, usage situations and the like. For example, a delegation relationship storage section 13a and voting state storage section 13b may be integrated. Furthermore, all or any part of each processing function performed by each apparatus can be realized by a CPU and a program which is analyzed and executed by the CPU or realized as hardware by a wired logic.

Furthermore, all or a part of the processings described as those to be automatically performed, among the processings described in this embodiment, may be manually performed, or all or a part of the processings described as those to be manually performed may be automatically performed in a well-known method. Furthermore, the processing procedures, control procedures, specific names, and information including various data and parameters shown in this document and the figures may be arbitrarily changed unless otherwise specified.

(4) Program

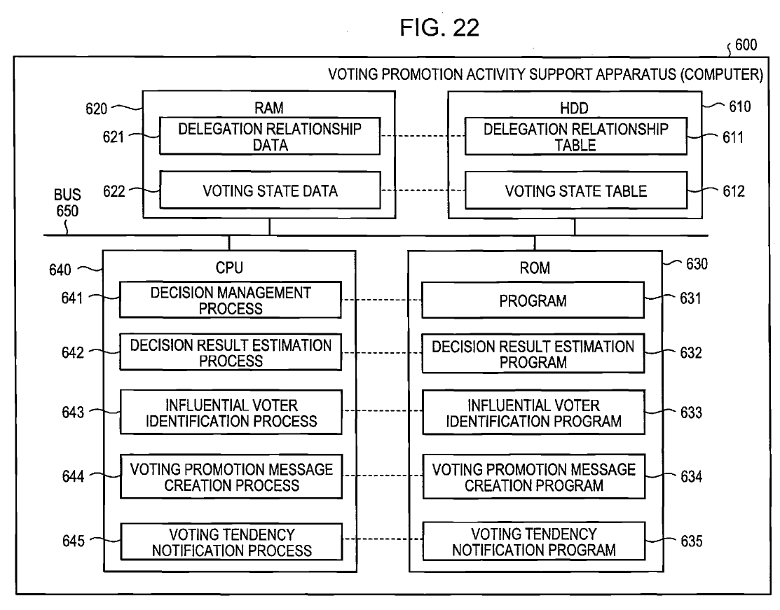

The various processings described in the embodiment described above can be realized by executing a program prepared in advance on a computer. Therefore, an example of a computer which executes a program having functions similar to those in the embodiment described above will be described below with the use of FIG. 22. FIG. 22 shows a computer which executes a voting promotion activity support program.

As shown in the figure, a computer 600 as the voting promotion activity support program is configured by connecting an HDD 610, a RAM 620, a ROM 630 and a CPU 640 via a bus 650.

In the ROM 630, a decision management program 631, a voting promotion activity support program 632, an influential voter identification program 633, a voting promotion message creation program 634 and a voting tendency notification program 635 are stored in advance as shown in FIG. 22. The programs 631 to 635 may be integrated or distributed as appropriate, similarly to the components of the voting promotion activity support apparatus shown in FIG. 2.

By the CPU 640 reading these programs 631 to 635 from the ROM 630 and executing them, the programs 631 to 635 function as a decision management process 641, a decision result estimation process 642, an influential voter identification process 643, a voting promotion message creation process 644 and a voting tendency notification process 645, respectively, as shown in FIG. 22. The processes 641 to 645 correspond to the decision management section 12a, the decision result estimation section 12b, the influential voter identification section 12c, the voting promotion message creation section 12d and the voting tendency notification section 12e, respectively.

A delegation relationship table 611 and a voting state table 612 are provided in the HDD 610 as shown in FIG. 22. The delegation relationship table 611 and the voting state table 612 correspond to the delegation relationship storage section 13a and the voting state storage section 13b shown in FIG. 2, respectively. The CPU 640 registers data with the delegation relationship table 611 and the voting state table 612, reads delegation relationship data 621 and voting state data 622 from the delegation relationship table 611 and the voting state table 612 and stores them in the RAM 620, and executes processing on the basis of the delegation relationship data 621 and the voting state data 622 stored in the RAM 620.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of transmission communication media includes a carrier-wave signal.

Further, according to an aspect of the embodiments of the invention, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A computer-readable recording medium storing a voting promotion activity support program for voting promotion activities at a middle stage of a voting process by multiple voters, by causing a computer to execute operations comprising:
accepting, from each voter, registration of one or more different voters as candidates for a delegatee to whom use of a part or all of votes held by the voter is delegated when the voter does not vote;
storing delegation relationship information in which the voter and the delegatee candidates are associated;
at a predetermined point of time after start of voting and before a voting expiration date, reading a voting state of each voter;
estimating an expected value of a number of votes held by each voter, which is a number of votes expected to be finally voted by each voter, based upon a probability value of a probability that a voter who has not voted yet at the point of time does not vote by the expiration date, and the stored delegation relationship information of the voter, based upon a calculation model for the voter who has not voted yet at the point of time point does not vote by the expiration time as a not-yet-voter, by delegating the votes held by the not-yet-voter to a delegatee of the voter as delegated votes and adding the delegated votes as votes held by a delegatee voter; and
identifying a voter whose expected value of the number of held votes estimated is large, as an influential voter who should be preferentially encouraged to vote.

2. A computer-readable recording medium storing a voting promotion activity support program for voting promotion activities at a middle stage of a voting process by multiple voters, by causing a computer to execute operations comprising:
accepting, from each voter, registration of one or more different voters as candidates for a delegatee to whom use of a part or all of votes held by the voter is delegated when the voter does not vote;
storing delegation relationship information in which the voter and the delegatee candidates are associated;
at a predetermined point of time after start of voting and before a voting expiration date, reading the voting state of each voter
estimating an expected value of a number of votes held by each voter, which is a number of votes expected to be finally voted by each voter, based upon a probability value of a probability that a voter who has not voted yet at that the point time does not vote by the expiration date, and the stored delegation relationship information of the voter, based upon a calculation model for the voter who has not voted yet at the point of time does not vote by the expiration time as not-yet-voter, by delegating the votes held by the not-yet-voter to a delegatee as delegated votes and adding the delegated votes as votes held by a delegatee voter; and
estimating a final number of votes obtained for each voting choice by extracting voters who have already voted from the voting states of the voters at the predetermined point of time and calculating the total of the estimated expected values of the number of held votes for the respective extracted voters who have already voted, for each vote choice for which the voters have voted.

3. The computer-readable recording medium according to claim 2, wherein the computer operations further comprise:
extracting, for a particular voter, voters associated with the voter by a direct delegation relationship as vicinity voters, based upon the stored delegation relationship; and
calculating the total of the estimated expected values of the number of held votes for the vicinity voters extracted, and for each vote choice for which the voters have voted, and estimating an expected value corresponding to contribution by the vicinity voters in the final number of votes obtained for each vote choice.

4. The computer-readable recording medium according to claim 3, further comprising:
storing a voting promotion message template;
selecting, for a particular voter, a vote choice that the expected value corresponding to the contribution by the vicinity voters is large, as a prevailing vote choice from among the vicinity voters based upon the estimated expected value corresponding to the contribution by the vicinity voters;
selecting a vote choice having a large expected value of the number of obtained votes as a prevailing vote choice from among all voters, estimated expected values of the number of votes obtained for the vote choices;
selecting a template to be used for creation of a voting promotion message in accordance with whether the prevailing vote choice from among the vicinity voters and the prevailing vote choice from among all the voters correspond to each other; and
creating a voting promotion message based upon the selected template.

5. A voting promotion activity support apparatus promoting voting at a middle stage of a voting process by multiple voters, the apparatus comprising:
delegatee storage means for accepting, from each voter, registration of one or more different voters in advance as candidates for a delegatee to whom use of a part or all of votes held by the voter is delegated when the voter does not vote, and storing delegation relationship information in which the voter and the delegatee candidates are associated, into a delegation relationship storage section;
held vote estimation means for, at a predetermined point of time after start of voting and before a voting expiration date, reading a voting state of each voter at the point of time, from a voting state storage section in which the voting state is recorded, and estimating an expected value of a number of votes held by each voter, which is a number of votes expected to be finally voted by each voter, based upon a probability value of a probability that a voter who has not voted yet at the point of time does not vote in by the expiration date, and the delegation relationship information stored in the delegation relationship storage section, according to a calculation model for the voter who has not voted yet at the point of time does not vote by the expiration time, by delegating the votes held by the voter to a delegatee as delegated votes and adding the delegated votes as votes to be held by a delegate voter; and
means for identifying a voter whose expected value of the number of held votes estimated by the held vote estimation means is large, as an influential voter who should be preferentially encouraged to vote.

6. A voting promotion activity support method promoting voting at a middle stage of a voting process by multiple voters, the method comprising:
accepting, from each voter, registration of one or more different voters in advance as candidates for a delegatee to whom use of a part or all of votes held by the voter is delegated when the voter does not vote;
storing delegation relationship information in which the voter and the delegatee candidates are associated;
at a predetermined point of time after start of voting and before a voting expiration date, reading the voting state of each voter;
estimating an expected value of a number of votes held by each voter, which is the number of votes expected to be finally voted by each voter, based upon a probability value of a probability that a voter who has not voted yet at the point of time does not vote by the expiration date, and the stored delegation relationship information, according to a calculation model for the voter who has not voted yet at the point of time does not vote by the expiration time, by delegating the votes held by the voter to a delegatee as delegated votes and adding the delegated votes as votes to be held by a delegatee voter; and
identifying a voter whose estimated expected value of the number of held votes is large, as an influential voter who should be preferentially encouraged to vote.

7. A computer-readable recording medium storing a voting promotion activity support program for voting promotion activities at a middle stage of a voting process by multiple voters, by causing a computer to execute operations comprising:
accepting, from each voter, registration of one or more different voters in advance as candidates for a delegatee to whom use of a part or all of votes held by the voter is delegated when the voter does not vote;
storing delegation relationship information in which the voter and the delegatee candidates are associated, into a delegation relationship storage section;
at a predetermined point of time after start of voting and before a voting expiration date, reading the voting state of each voter at the point of time;
estimating an expected value of a number of votes held by each voter, which is a number of votes expected to be finally voted by each voter, based upon a probability value of a probability that a voter who has not voted yet at the point of time does not vote by the expiration time, and the delegation relationship information, according to a calculation model for the voter who has not voted yet at the point of time does not vote by the expiration time, by delegating the votes held by the voter to a delegatee as delegated votes and adding the delegated votes as votes to be held by a delegatee voter; and
creating a list of voters whom an administrator preferentially encourages to vote, as voting promotion information, with priorities based on the estimated expected values of the number of held votes.

8. An apparatus promoting voting, comprising:
a computer controller
accepting, from each voter, registration of one or more different voters as candidates for a delegatee to whom use of a part or all of votes held by the voter is delegated when the voter does not vote;
associating the voter and the delegatee candidates; and
at a predetermined point of time after start of voting and before a voting expiration date,
reading a voting state of each voter,
estimating an expected value of a number of votes held by each voter, based upon a probability that a voter who has not voted yet at the point of time does not vote by the expiration date, by delegating the votes held by the voter to a delegatee as delegated votes according to the associating of the voter with the delegatee candidates and adding the delegated votes as votes to be held by a delegatee voter; and
identifying a voter whose expected value of a number of held votes estimated is large, as an influential voter who should be preferentially encouraged to vote.
